(19) United States
(12) Patent Application Publication
(10) Pub. No.: US 2017/0353272 A1
(43) Pub. Date: Dec. 7, 2017

(54) USER TERMINAL, RADIO BASE STATION AND RADIO COMMUNICATION METHOD

(71) Applicant: NTT DOCOMO, INC., Tokyo (JP)

(72) Inventors: Kazuaki Takeda, Tokyo (JP); Shimpei Yasukawa, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 15/524,777

(22) PCT Filed: Oct. 21, 2015
(86) PCT No.: PCT/JP2015/079630

§ 371 Date: May 5, 2017

(30) Foreign Application Priority Data
Nov. 6, 2014 (JP) 2014-226492

(51) Int. Cl. H04L 1/16; H04W 72/04; H04W 72/12

(52) U.S. Cl. CPC H04L 1/16; H04W 72/0453; H04W 72/042; H04W 72/1268

(57) ABSTRACT

The present invention is designed so that the efficiency of use of UL resources is prevented from decreasing even when the band to use is limited to partial narrow bands in the system band. According to one aspect of the present invention, a user terminal, in which the band to use is limited to partial narrow bands in the system band, has a receiving section that receives downlink control information that relates to a resource to allocate to a PDSCH (Physical Downlink Shared Channel), in an EPDCCH (Enhanced Physical Downlink Control Channel), and receives the PDSCH based on the downlink control information, a transmission section that transmits a PUCCH (Physical Uplink Control Channel) in response to the PDSCH, and a control section that controls a PUCCH resource based on a PRB (Physical Resource Block) index that corresponds to the PDSCH.

### TECHNICAL FIELD

The present invention relates to a user terminal, a radio base station and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (also referred to as, for example, “LTE-advanced” (hereinafter referred to as “LTE-A”),“FRA” (Future Radio Access) and so on) are under study for the purpose of achieving further hroadbandization and increased speed beyond LTE.

Now, accompanying the cost reduction of communication devices in recent years, active development is in progress in the field of technology related to machine-to-machine communication (M2M) to implement automatic control of network-connected devices and allow these devices to communicate with each other without involving people. In particular, of all M2M, 3GPP (3rd Generation Partnership Project) is promoting standardization with respect to the optimization of MTC (Machine-Type Communication), as a cellular system for machine-to-machine communication (see non-patent literature 2). MTC terminals are being studied for use in a wide range of fields, such as, for example, electric (gas) meters, vending machines, vehicles and other industrial equipment.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

Non-Patent Literature 2: 3GPP TS 36.888 “Study on provision of low-cost Machine-Type Communications (MTC) User Equipments (UEs) based on LTE (Release 12)”

### SUMMARY OF INVENTION

### Technical Problem

From the perspective of reducing the cost and improving the coverage area in cellular systems, amongst all MTC terminals, low-cost MTC terminals (low-cost MTC UEs) that can be implemented in simple hardware structures have been increasing in demand. Low-cost MTC terminals can be implemented by limiting the band to use in the uplink (UL) and the downlink (DL) to a portion of a system band. However, if existing resource allocation schemes, which are designed based on a system band, are applied to PUCCH (Physical Uplink Control Channel) resource allocation, it is likely to waste PUCCH resources and damage the efficiency of use of UL resources.

The present invention has been made in view of the above, and it is therefore an object of the present invention to provide a user terminal, a radio base station and a radio communication method that can prevent the efficiency of use of UL resources from decreasing even when the band to use is limited to partial narrow bands in a system band.

### Solution to Problem

One aspect of the present invention provides a user terminal, in which the band to use is limited to partial narrow bands in the system band, and this user terminal has a receiving section that receives downlink control information that relates to a resource to allocate to a PDSCH (Physical Downlink Shared Channel), in an EPDCCH (Enhanced Physical Downlink Control Channel), and receives the PDSCH based on the downlink control information, a transmission section that transmits a PUCCH (Physical

Uplink Control Channel) in response to the PDSCH, and a control section that controls a PUCCH resource based on a PRB (Physical Resource Block) index that corresponds to the PDSCH.

### Advantageous Effects of Invention

According to the present invention, it is possible to prevent the efficiency of use of UL resources from decreasing even when the band to use is limited to partial narrow bands in the system band.

### BRIEF DESCRIPTION OF DRAWINGS

FIG. 1 provide diagrams, each showing an example of the arrangement of narrow bands in a downlink system band;

FIG. 2 is a diagram to show an example of PDSCH allocation in MTC terminals;

FIG. 3 is a diagram to show an example of EPDCCH/PDSCH allocation in the event of 3-PRB localized transmission;

FIG. 4 provide diagrams, each showing an example of PUCCH resource allocation according to a first embodiment;

FIG. 5 is a diagram to show a gap between PUCCH transmission timings of user terminals where different numbers of times to repeat a PDSCH are configured;

FIG. 6 provide diagrams to show examples of information about offsets, included in EPDCCH DCI;

FIG. 7 is a diagram to show an example of the case where a second embodiment is applied to the example of FIG. 5;

FIG. 8 provide diagrams to show examples of information about the number of repetitions, included in EPDCCH DCI;

FIG. 9 is a diagram to show an example of the case where a second embodiment is applied to the example of FIG. 5;

FIG. 10 provide diagrams to show examples of linkages between PDSCH sets and PUSCH sets;

FIG. 11 is a diagram to show a schematic structure of a radio communication system according to an embodiment of the present invention;

FIG. 12 is a diagram to show an example of an overall structure of a radio base station according to an embodiment of the present invention;

FIG. 13 is a diagram to show an example of a functional structure of a radio base station according to one embodiment of the present invention;

FIG. 14 is a diagram to show an example of an overall structure of a user terminal according to an embodiment of the present invention; and

FIG. 15 is a diagram to show an example of a functional structure of a user terminal according to an embodiment of the present invention,

### DESCRIPTION OF EMBODIMENTS

A study in progress to limit the processing capabilities of terminals by making the peak rate low, limiting the resource blocks, allowing limited RF reception and so on, in order to reduce the cost of MTC terminals. For example, the maximum transport block size in unicast transmission using a downlink data channel (PDSCH: Physical Downlink Shared Channel) is limited to 1000 bits, and the maximum transport block size in BCCH transmission using a downlink data channel is limited to 2216 bits. Furthermore, the downlink data channel bandwidth is limited to 6 resource blocks (also referred to as “RBs” (Resource Blocks), “PRBs” (Physical Resource Blocks), etc.). Furthermore, the RFs to receive in MTC terminals are limited to one.

Furthermore, the transport block size and the resource blocks in low-cost MTC terminals (low-cost MTC UEs) are more limited than in existing user terminals, and therefore low-cost MTC terminals cannot connect with cells in compliance with LTE Rel. 8 to 11. Consequently, low-cost MTC terminals connect only with cells where a permission of access is reported to the low-cost MTC terminals in broadcast signals. Furthermore, a study is in progress to limit not only downlink data signals, but also various control signals that are transmitted on the downlink (such as system information, downlink control information and so on), data signals and various control signals that are transmitted on the uplink, and/or other signals to predetermined narrow bands (for example, 1.4 MHz).

Such band-limited MTC terminals need to be operated on the LTE system band, considering the relationship with existing user terminals. For example, in a system band, frequency-multiplexing of band-limited MTC terminals and hand-unlimited existing user terminals is supported. Furthermore, the band-limited user terminals can only support predetermined narrow-band RFs in the uplink and the downlink. Here, the MTC terminals are terminals that support only partial narrow bands in the system band as the maximum band they can support, and the existing user terminals are terminals that support the system band (for example, 20 MHz) as the maximum band they can support.

That is, the upper limit of the band for use by MTC terminals is limited to narrow bands, and, for existing user terminals, the system band is configured as the upper limit of the band to use. MTC terminals are designed presuming narrow bands, and therefore the hardware structure is simplified, and their processing capabilities are low compared to existing user terminals. Note that MTC terminal may be referred to as “low-cost MTC terminals,” “MTC UEs” and so on. Existing user terminals may be referred to as “normal UEs,” “non-MTC UEs,” category 1 UEs” and so on.

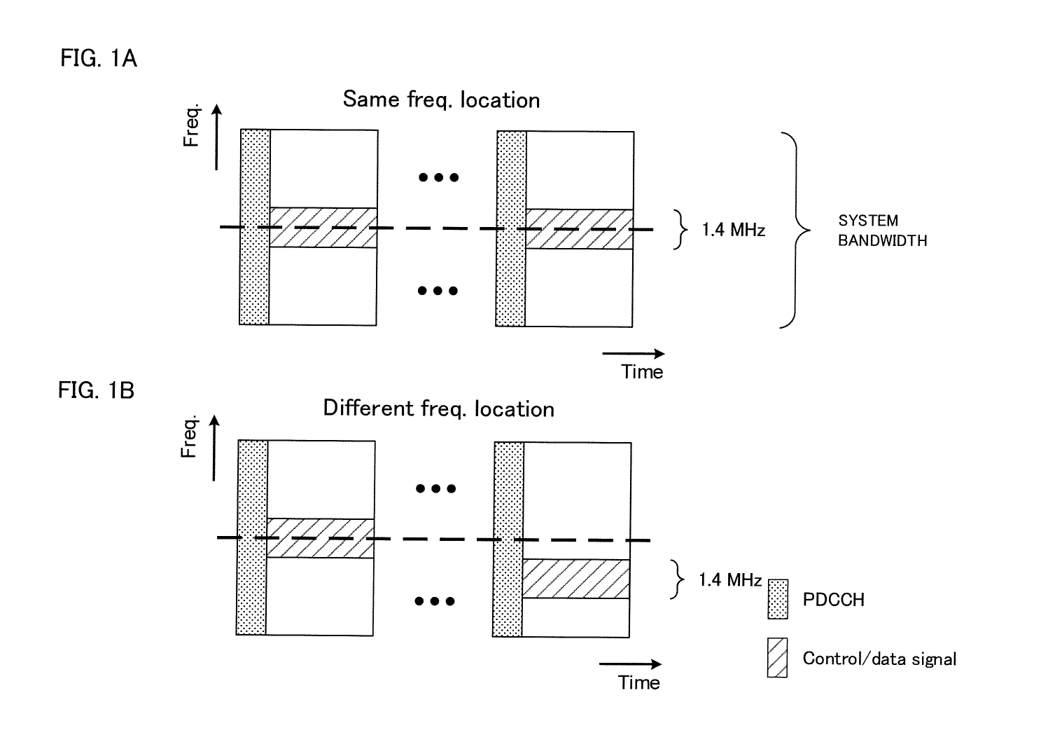

Now, the arrangement of narrow bands in a downlink system band will be described with reference to FIG. 1. As shown in FIG. 1A, the band for use for MTC terminals is limited to a partial narrow band (for example, 1.4 MHz) in a system band. When a narrow band is fixed in a predetermined frequency location in a system band, no frequency diversity effect can be achieved, and therefore the spectral efficiency might decrease. On the other hand, as shown in FIG. 1B, when a narrow band to constitute the band to use changes its frequency location in every subframe, a frequency diversity effect can be achieved, and therefore the decrease of spectral efficiency can be reduced.

Now, since MTC terminals only support 1.4-MHz narrow bands, it is not possible to detect downlink control information (DCI) that is transmitted in a wideband PDCCH. So, it may be possible to allocate downlink (PDSCH) and uplink (PUSCH: Physical Uplink Shared Channel) resources to MTC terminals by using an EPDCCH (Enhanced Physical Downlink Control Channel).

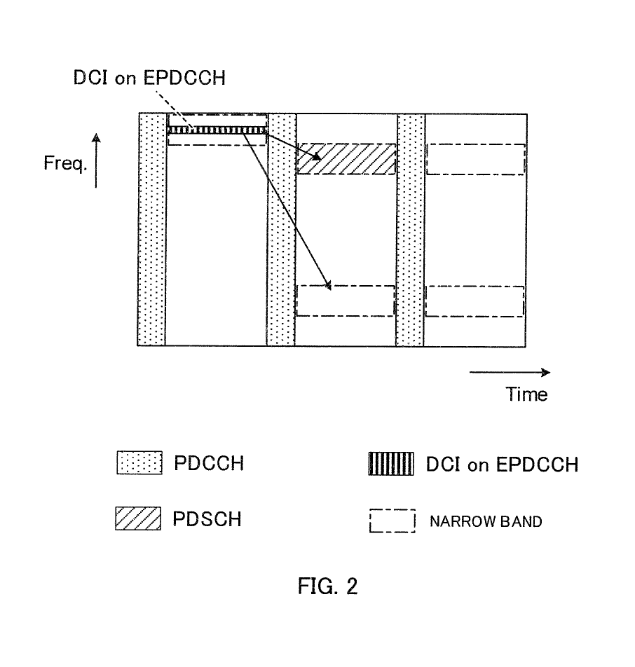

FIG. 2 is a diagram to show an example of PDSCH allocation in MTC terminals. As shown in FIG. 2, first, an EPDCCH is allocated to a predetermined narrow band. Information about the frequency location where the EPDCCH is allocated may be reported by higher layer signaling (for example, RRC signaling, broadcast signals, etc.) or may be configured in user terminals in advance.

Two types of EPDCCH transmission methods may be possible-namely, distributed transmission and localized transmission. The downlink radio resources to allocate an EPDCCH are arranged to be distributed in a discontinuous manner in distributed transmission, and are arranged continuously in localized transmission. Furthermore, the resources to allocate an EPDCCH are selected from a set of resource elements that can be used (enhanced control channel elements (ECCEs)).

The EPDCCH includes DCI that relates to the resources to allocate a PDSCH. Candidate radio resources where a PDSCH can be allocated (PDSCH sets) are reported to the user terminal via higher layer signaling, and one of the PDSCH sets is dynamically selected based on the DCI. For example, in FIG. 2, in the next subframe after the EPDCCH is transmitted, the user terminal learns which PDSCH set the user terminal should receive, based on the DCI, and receives the PDSCH. Note that, the PDSCH may be received in the same subframe the EPDCCH is received.

The user terminal receives the PDSCH in the allocated resources specified by the EPDCCH, and transmits an HARQ-ACK in response to this PDSCH by using a PUCCH (Physical Uplink Control Channel).

In conventional LTE, regardless of which of the two types of EPDCCH transmission methods is used, the resources to allocate a PUCCH are determined in association with ECCE indices. Furthermore, in the resources where a PUCCH is allocated, the ECCE indices can be shifted based on an ARO (ACK/NACK Resource Offset) field that is reported in a downlink control signal (DCI).

As described above, PUCCH resources are determined in association with ECCEs. That is, the number of PUCCH resources that need to be reserved changes depending on the number of ECCEs that can be used. For example, in the event of localized transmission, assuming that the number of ECCEs per PRB (one EPDCCH) is 4, 8 PUCCH resources are required for 2 PRBs, and 12 PUCCH resources are required for 3 PRBs.

However, an MTC terminal, in which the band to use is limited to narrow bands, does not need this many PUCCH resources. Furthermore, in PRBs that are determined as PUCCH resources, UL signals other than PUCCHs (the PDSCH and so on) cannot be transmitted, in order to reduce the interference against control signals. Consequently, if the conventional PUCCH-resource determining method is used, it is likely to waste PUCCH resources and damage the uplink spectral efficiency.

So, the present inventors have focused on the fact that, in MTC terminals, the number of PRBs that can be actually used is smaller than the number of ECCEs configured in conventional LTE. Focusing on this point, the present inventors have worked on the method of determining PUCCH resource locations without using ECCEs, and arrived at the present invention.

Now, embodiments of the present invention will be described below. Assume that, in each embodiment, the relationship between the downlink narrow band in which a PDSCH is received and the uplink narrow band in which a PUCCH is transmitted in response to the PDSCH are determined in advance. Note that the application of the present invention is by no means limited to this, and this will be explained later.

Although MTC terminals will be shown as an example of user terminals in which the band to use is limited to narrow bands, the application of the present invention is not limited to MTC terminals. Furthermore, although 6-PRB (1.4-MHz) narrow bands will be described below, the present invention can be applied to other narrow bands as well, based on the present description.

### First Embodiment

The first embodiment of the present invention specifies PUCCH resources by using PDSCH PRB indices instead of ECCE indices. In MTC terminals, the number of PRB indices is likely to be smaller than the number of ECCE indices conventionally used to determine PUCCH resources, so that, according to the present embodiment, it is possible to avoid reserving unnecessary PUCCH resources.

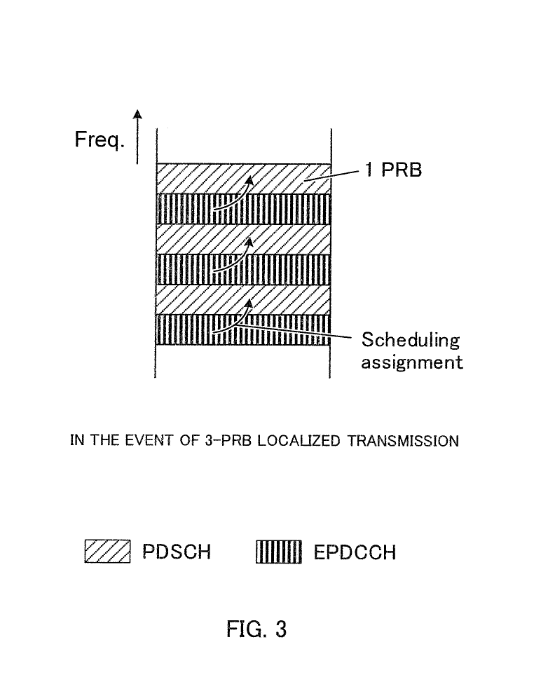

For example, assuming an MTC terminal in which the band to use is limited to 6 PRBs (1.4 MHz), even if one PDSCH PRB is to be allocated per UE, it is only necessary to allocate maximum 3 PDSCH PRBs. FIG. 3 is a diagram to show example of allocation of EPDCCHs/PDSCHs in the event of 3-PRB localized transmission.

Referring to FIG. 3, the EPDCCHs contain information for PDSCH scheduling assignment. This information for scheduling assignment may include, for example, information that represents the locations of PDSCH resources. The information to represent the locations of PDSCH resources may be, for example, a PRB index (for example, one of 0 to 5) within a predetermined narrow band (for example, 6 RBs), or may be a relative frequency offset to the locations of EPDCCH resources. Note that a user terminal may identify the locations of PDSCH resources implicitly based on the locations of EPDCCH resources. For example, the locations of PDSCH resources may be determined as being the locations where one PRB of frequency is added to the locations of resources where an EPDCCH is detected.

An MTC terminal specifies the PRB of a PDSCH received in a predetermined narrow band (PDSCH set). To specify the PRB, for example, the PRB index can be used. Furthermore, the PUCCH resources for transmitting an ACK/NACK in response to the PDSCH can be specified in association with the PDSCH's PRB index. For example, the PUCCH resources may be determined as a function of the PDSCH's PRB index.

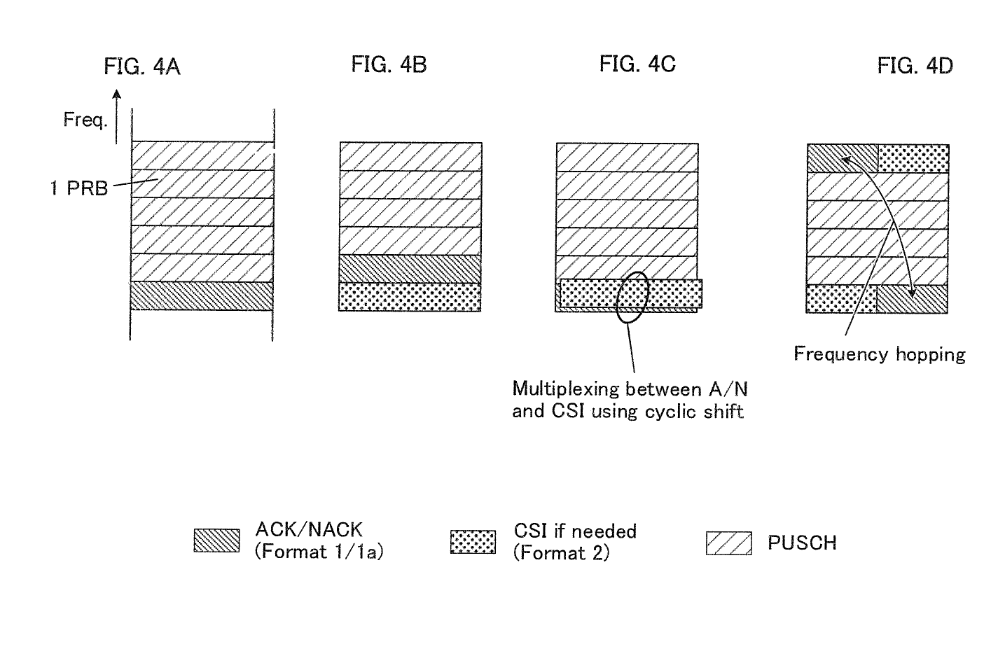

According to the present embodiment, 6 PUCCH resources suffice for MTC terminals, and therefore the PUCCH resources are likely to be within one PRB. FIG. 4 provide diagrams to show examples of PUCCH resource allocation according to the first embodiment. Note that the radio resources where PUCCH resources are not allocated can be used as PUSCH resources.

FIG. 4A shows an example of allocating PUCCH format 1/1A for ACK/NACK to one PRB at an edge of a narrow band. While existing user terminals have heretofore determined the PUCCH resources based on ECCEs in predetermined areas in the system band (for example, at both edges of the system band), the user terminal of the present embodiment can determine these resources more easily based on the PRB index that specifies the PDSCH received.

The PUCCH resources for an ACK/NACK may be allocated apart from one PRB at an edge of a narrow band. FIG. 4B shows an example, in which PUCCH format 2 for CSI (Channel State Information) is assigned to one PRB at an edge of a narrow band, and in which, in one PRB that neighbors this PRB, PUCCH format 1/1A is assigned.

Also, the PUCCH resources for an ACK/NACK may be multiplexed on the same resources with other signals. FIG. 4C shows an example, in which an ACK/NACK PUCCH resource and a CSI PUCCH resource are multiplexed on one PRB at an edge of a narrow band by applying a cyclic shift. In this case, many resources need to be reserved in order to apply a cyclic shift to the CSI, so that it is preferable to reduce the ACK/NACK PUCCH resources based on the present embodiment. Note that the method of multiplexing is by no means limited to cyclic shift, and, for example, orthogonal sequences may be used.

Furthermore, ACK/NACK PUCCH resources and CSI PUCCH resources may be subject to frequency hopping within a narrow band. FIG. 4D shows an example in which PUCCH resources are allocated to one PRB, at both edges of a narrow band by way of hopping. The hopping may be applied in slot units or in subframe units.

Note that, when the user terminal is commanded to transmit a PUSCH at the timing a PUCCH is transmitted, the user terminal may transmit the contents of the PUCCH (ACK/NACK, CSI and so on) in the PUSCH.

As described above, according to the first embodiment, it is possible to reduce the PUCCH resources for ACKs/NACKs by using PDSCH PRB indices. For example, when there are 3 PRBs as shown in FIG. 3, it has heretofore been necessary to reserve 12 PUCCH resources in conventional LTE (when the number of ECCEs per PRB is 4), but, according to the present embodiment, only 6 PUCCH resource need to be reserved at a maximum even when there are 6 PRBs.

### Second Embodiment

A second embodiment of the present invention relates to a method of determining PUCCH resources when the same PDSCH is transmitted in repetitions.

In Rel-13 LTE, coverage enhancement for MTC terminals is under study. As one method of coverage enhancement, a study is progress to repeat transmitting the same PDSCH by using a plurality of subframes. In this case, an MTC terminal can combine a plurality of subframes in which an PDSCH is transmitted, and thus decode the received PDSCH efficiently. Note that transmission may be repeated in the same frequency resource, or may be repeated in different frequency resources in every subframe, by using hopping.

The number of times to repeat transmission may be determined based on the relationship between the locations of a user terminal and a radio base station, the received quality in a user terminal and so on. For example, the number of times to repeat transmitting a PDSCH to a user terminal on a cell edge may be configured smaller than the number of times to repeat transmitting a PDSCH to a user terminal at the center of the cell. Furthermore, the number of repetitions may be reported to user terminals in a control signal (DCI), by using higher layer signaling (for example, RRC signaling, broadcast information) and so on.

For a PDSCH in coverage enhancement mode, it may be possible to determine the PUCCH resources for an ACK in response to the PDSCH in association with the EPDCCH/PDSCH in the last subframe received in a user terminal. However, in this case, if varying numbers of times to repeat transmitting a PDSCH are configured among a plurality of user terminals, the PUCCH transmission timing varies in every user terminal.

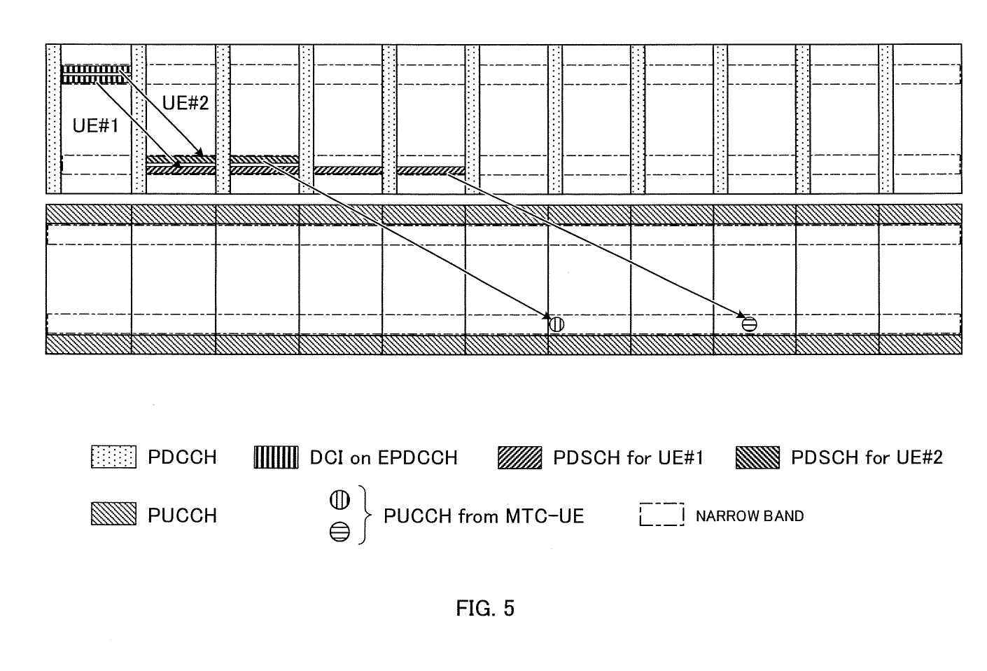

FIG. 5 is a diagram to show a gap between PUCCH transmission timings of user terminals where different numbers of times to repeat a PDSCH are configured. In FIG. 5, first, an EPDCCH is transmitted each of two user terminals (UE #1 and UE #2). Also, PDSCHs for the UEs are transmitted. Here, the number of times to repeat the PDSCH for UE #1 is 4, and the number of times to repeat the PDSCH for UE #2 is 2. Note that FIG. 5 shows an example in which a PUCCH is not transmitted in repetitions.

UE #1 and UE #2 each receive the PDSCH in a plurality of subframes, in repetitions, by using resources that are specified by the EPDCCH for the subject terminal. Also, a predetermined period of time (for example, 4 subframes) after the last subframe in which the PDSCH was received, UE #1 and UE #2 each transmit an ACK/NACK in response to this PDSCH, by using predetermined PUCCH resources. Consequently, in FIG. 5, UE #1 and UE #2 transmit PUCCHs in different subframes. These PUCCH resources may be determined by using, for example, the above-described method of the first embodiment.

As mentioned earlier, in PRBs that are determined as PUCCH resources, UL signals (PDSCH and so on) other than PUCCHs cannot be transmitted. Consequently, if a different number of repetitions is applied to the PDSCH transmission for each user terminal, the PUCCH resources are allocated over a plurality of subframes, and this may damage the efficiency of use of UL resources (or damage the rate of UL signal transmission).

So, the present inventors have studied allowing a plurality of user terminals to transmit PUCCHs in the same subframe even when different numbers of repetitions are applied to these user terminals, and arrived at the second embodiment of the present invention. To be more specific, according to the second embodiment, a plurality of user terminals are controlled to transmit PUCCHs in the same resources (the time resources are in the same subframe, and the frequency resources are in the same PRB).

According to the second embodiment, a user terminal decides the subframe to make PUCCH transmission based on one of the following methods:

(Method 1) The offset of the subframe for making PUCCH transmission is included in DCI, and the decision is made based on this offset.

(Method 2) The decision is made based on the maximum number of repetitions in the currently connecting cell.

When method 1 is used, based on the offset-related information (offset information) included in EPDCCH DCI, a user terminal transmits a PUCCH in a subframe that is a shift away, in the direction of time, from a subframe that is calculated from the last subframe in which the PDSCH is received. The offset information may be defined by using a hit field that is defined anew in the DCI, may be defined by using an existing bit field, or may be defined by using a combination of these. Although an example to interpret ARO (ACK/NACK Resource Offset) as the offset information will be described below, this is by no means limiting. Furthermore, the offset information is not limited to 2 bits.

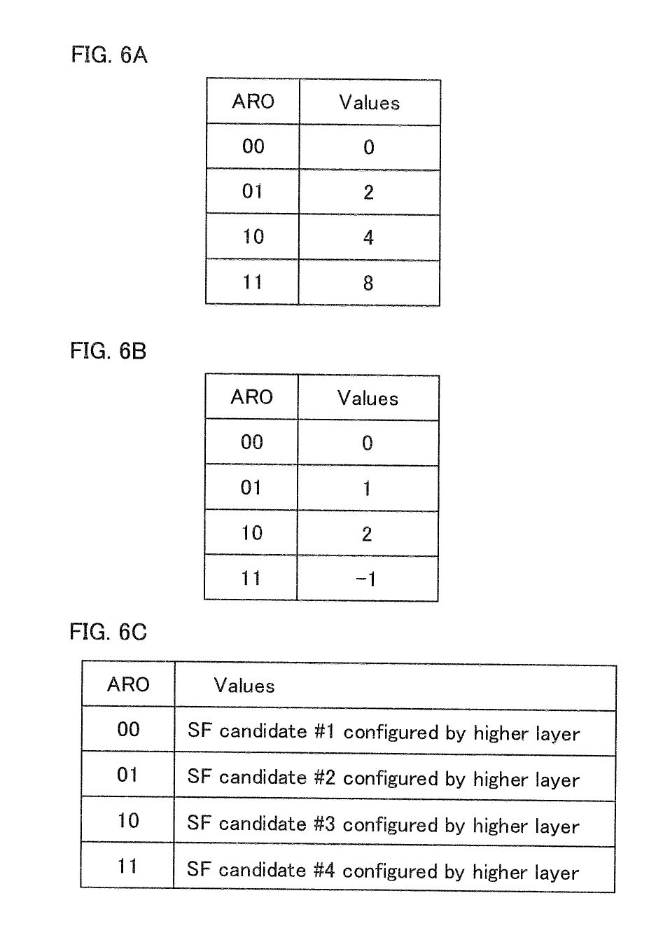

The offset information shows a relative offset value to predetermined subframe. FIG. 6 is a diagram to show an example of the offset-related information included in EPDCCH DCI.

The offset information may be structured to indicate, for example, a relative offset value to the last subframe in which the PDSCH is received in each user terminal. A shown in FIG. 6A, the offset information may be configured so that each offset value doubles its preceding value. Referring to FIG. 6A, when the ARO is “01” and a subframe is calculated based on the last subframe the PDSCH was received, the user terminal may be controlled to transmit a PUCCH two more subframes after this subframe.

Also, the offset information may represent the offset value to the subframe in which the EPDCCH was received or the subframe in which the PDSCH started being received. For example, referring to FIG. 6A, when the ARO is “11,” the user terminal may be controlled to transmit a PUCCH 8 subframes after the subframe in which the EPDCCH is received.

As shown in FIG. 6B, a configuration to include negative offset values is also possible. In FIG. 6B, when the ARO is “11” and a subframe is calculated based on the last subframe the PDSCH was received, the user terminal may be controlled to transmit a PUCCH one subframe before this subframe.

Furthermore, as shown in FIG. 6C, the offset information may indicate a candidate of a subframe (SF candidate) in which a PUCCH can he transmitted, and configure this candidate by higher layer signaling. By this means, flexible PUCCH resource control becomes possible.

Note that it is preferable to include “0 ” as an offset value to represent offset information. For example, when different user terminals′ PUCCH resources are transmitted in the same subframe and collide with each other, such collisions may be avoided by configuring each user terminal's offset value to 0.

Also, the linkages between the offset information and the offset values may be switched depending on predetermined signals, parameters and so on. For example, the offset values to correspond to the offset information may be determined as a function of the number of times a PDSCH is repeated. For example, when the number of repetitions is 2, it is possible to make 0, 2, 4 and 8 the values to correspond to the offset information, and, when the number of repetitions is 1, it is possible to make 0, 1, 2 and 4 the values to correspond to the offset information.

In the event method 2 is used, when the EPDCCH gives a command to the user terminal to receive a PDSCH, the user terminal performs the PDSCH receiving process based on the number of repetitions configured in the subject terminal, and transmits an ACK/NACK in response to this PDSCH at a timing that is determined based on the subframe to be the last subframe when the PDSCH is transmitted in the maximum number of repetitions.

Here, the maximum number of times to repeat a PDSCH in a predetermined cell may be reported from the radio base station to the user terminal via higher layer signaling (for example, RRC signaling, broadcast signal (SIB) and so on). Also, the maximum number of times to repeat a PDSCH may be configured in advance in the user terminal.

According to method 2, it is possible to synchronize each user terminal's PUCCH timing based on simpler control than in method 1.

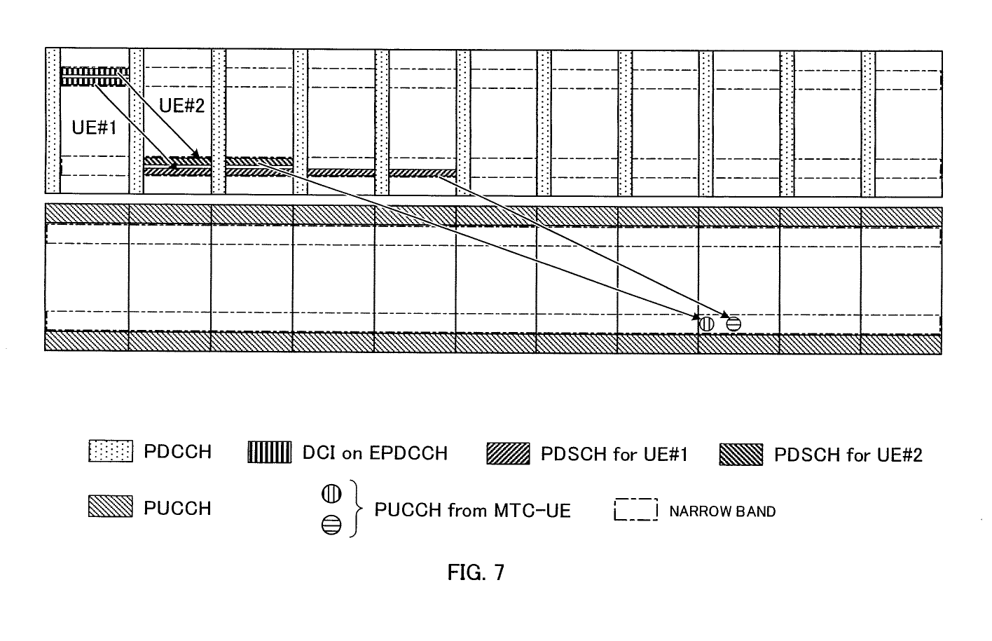

FIG. 7 is a diagram to show an example in which the second embodiment is applied to the example of FIG. 5. FIG. 7 is the same as FIG. 5 except for the timing to transmit PUCCHs in response to PDSCHs. In FIG. 7, in the cell where UE #1 and UE #2 are connected, the maximum number of times to repeat a PDSCH is 4.

If method 1 is used, for example, the ARO “00” in FIG. 6B is reported to UE #1, and the ARO “10” in FIG. 6B is reported to UE #2. By this means, UE #1 determines the timing to transmit a PUCCH based on the last subframe in which the PDSCH was received, without an offset. On the other hand, UE #2 determine the timing to transmit a PUCCH, taking into account the last subframe the PDSCH was received and the two-subframe offset represented by the offset information.

In method 2, each user terminal is reported in advance that the maximum number of times to repeat a PDSCH is 4 in the residing cell. By this means, UE #1 can recognize when the PDSCH for the subject terminal is transmitted the same number of times as the maximum number of repetitions, and determine the PUCCH transmission timing based on the last subframe. On the other hand, UE #2 recognizes when the number of times the PDSCH for the subject terminal is transmitted is less than the maximum number of repetitions. In this case, UE #2 determines the PUCCH transmission timing, not based on the last subframe in which the PDSCH was received, but based on the subframe that corresponds to the maximum number of repetitions (the last subframe for UE #1).

Consequently, regardless of which method is used, the PUCCH resources for UE #1 and UE #2 are allocated to the same subframe, so that it is possible to prevent the efficiency of use of resources from decreasing.

Note that, although a case to determine PUCCH resources based on the last subframe in which a PDSCH was received has been described with the above example, this is by no means limiting. The second embodiment may be applied to cases where PUCCH resources are determined based on other subframes.

Also, although a case to control the PUCCH transmission timing of a plurality of user terminals to which EPDCCHs are reported in the same subframe has been described with the above example, this is by no means limiting. For example, it is also equally possible to control the PUCCH transmission timings in a plurality of user terminals to which EPDCCHs are reported in separate subframes.

Furthermore, even when varying user terminals′ PUCCH resources are transmitted in the same subframe and collide with each other, it is still possible to transmit these PUCCH resources in the same subframe. In this case, collisions can be avoided by applying frequency-shifts to the PUCCH resources of predetermined user terminals based on the ARI (ACK/NACK Resource Indicator) field included in DCI. Note that TPC (Transmit Power Control) field may be interpreted and used as an ARI if the DCI is a DL grant.

Note that, although an example case to transmit a PDSCH in repetitions has been described with the second embodiment, the subframe to transmit a PUCCH can be determined using the above-described methods even if a PDSCH is not transmitted in repetitions. For example, when a radio base station does not repeat transmitting a PDSCH, the radio base station may determine the offset information for each user terminal so that a plurality of user terminals, to which EPDCCH are reported in separate subframes, transmit PUCCHs in the same subframe.

Furthermore, when a radio base station finds out that a plurality of user terminals transmit PUCCHs within a predetermined period (for example, within several subframes), the radio base station may control these multiple user terminals to transmit PUCCHs in the same subframe. By this means, it is possible to reduce the maximum delay of PUCCH transmission that results from using shifted transmission timings.

### Third Embodiment

A third embodiment of the present invention relates a method of controlling PUCCH resource when a user terminal repeats transmitting the same PUCCH.

For user terminals, too, a configuration to transmit the same signal in repetitions is under study as a coverage enhancement mode. For example, a study is in progress to repeat transmitting a PUCCH the same number of times as the number of times to a PDSCH is repeated. However, if every user terminal repeat transmitting a PUCCH, PUCCH resources are configured in many subframes, and the spectral efficiency increases.

So, the present inventors have worked on allowing a radio base station to adjust the number of repetitions in user terminals, and arrived at the third embodiment of the present invention. According to the third embodiment, information about the number of repetitions is reported from a radio base station to a user terminal. The user terminal increases or decreases the number of times to repeat a PUCCH based on this information.

The information about the number of repetitions may be defined by using a bit field that is defined anew in DCI, may be defined by using an existing bit field, or may be defined by using a combination of these. Although an example to interpret ARO (ACK/NACK Resource Offset) as the information of the number of repetitions will be described below, this is by no means limiting. Furthermore, the information about the number of repetitions is not limited to 2 bits.

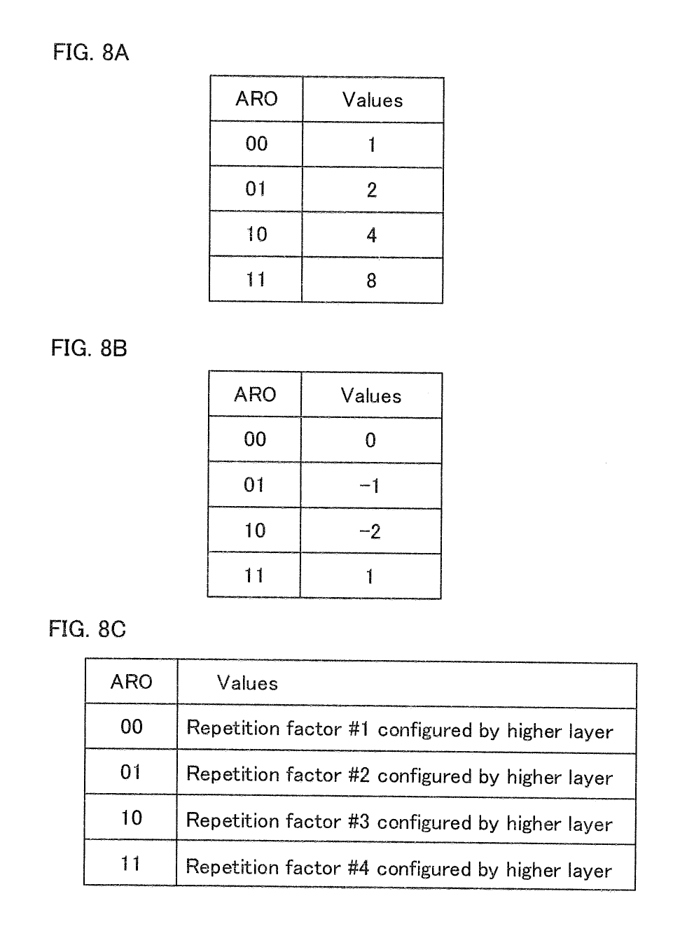

FIG. 8 provide diagrams to show examples of the information about the number of repetitions included in EPDCCH DCI. As shown in FIG. 8A, the information about the number of repetitions may show the absolute values of the numbers of repetitions. For example, when, in FIG. 8A, the ARO is “01,” a user terminal configures the number of times to repeat a PUCCH to 2, regardless of the number of times to repeat PDSCH.

As shown in FIG. 8B, the information about the number of repetitions may show the numbers of repetitions in relative values. For example, when, in FIG. 8B, the ARO is “01,” the user terminal subtracts 1 from the number of times to repeat a PDSCH minus 1, and configures the resultant value as the number of times to repeat a PUCCH.

Furthermore, as shown in FIG. 8C, PUCCH repetition factors may be configured by higher layer signaling. These factors may show the numbers of repetitions in absolute values as shown in FIG. 8A, or show the number of repetitions in relative values as shown in FIG. 8B. By this means, flexible PUCCH resource control becomes possible.

Note that it is preferable to transmit the information about the number of repetitions from the radio base station to user terminals when predetermined conditions are fulfilled. For example, if a PUCCH is received from a user terminal in a reliable manner, it is preferable to transmit information that lowers the number of repetitions, to this user terminal. For example, when DTX (Discontinuous transmission) is not included among the ACKs/NACKs transmitted from a user terminal over a predetermined period, it is preferable to transmit information that lowers the number of repetitions, to this user terminal.

Also, although examples to use ARO have been described with both the second embodiment and the third embodiment, whether ARO represents 1.0 information about offsets (second embodiment) or represents information about the number of repetitions (third embodiment) may be determined by user terminals. For example, a user terminal may judge the content of ARO based on whether or not a PUCCH is transmitted in repetitions. That is to say, if a user terminal is not configured to repeat transmitting a PUCCH, the user terminal may judge that ARO represents offset information, and, if the user terminal is configured to transmit a PUCCH in repetitions, the user terminal may judge that ARO represents information about the number of repetitions. Furthermore, the user terminal may judge ARQ differently based on reports provided via higher layer signaling (for example, RRC signaling).

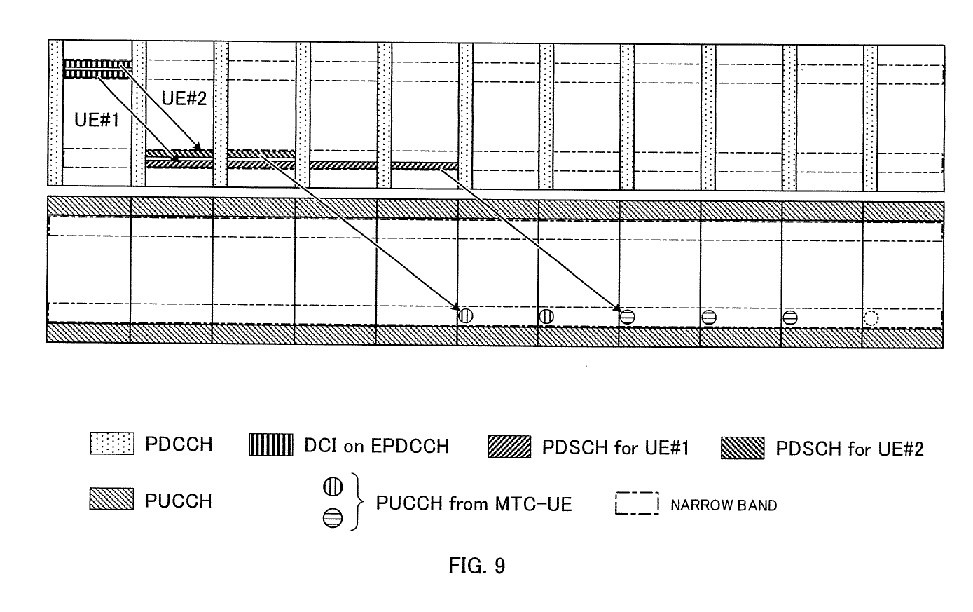

FIG. 9 is a diagram to show an example of applying the third embodiment to the example of FIG. 5. FIG. 9 is the same as FIG. 5 except that PUCCHs are transmitted in repetitions in response to PDSCHs. Assume that, in FIG. 9, the number of times to repeat a PUCCH is configured in advance to 2 in UE #1, and, likewise, the number of repetitions is configured in advance to 4 in UE #2.

For example, the ARO “01” in FIG. 8B is reported to UE #1, and the ARO “00” in FIG. 8B is reported to UE #2. By this means, UE #1 configures the number of times to repeat a PUCCH to 3, which is 4 minus 1, and transmits a PUCCH. On the other hand, UE #2 maintains the number of times to repeat a PUCCH at 2, and transmits a PUCCH. By this means, no PUCCH transmission takes place in the last subframe shown in FIG. 9, so that it is possible to reduce the PUCCH resources.

(Variation)

Although each embodiment above has been described assuming that the relationships between downlink narrow bands and uplink narrow hands are determined in advance, the application of the present invention is by no means limited to this. For example, information about the linkages between PDSCH sets, which are candidate bands that can be used to allocate PDSCHs (EPDCCHs), and PUSCH sets, which are candidate bands that can partially be used to allocate PUCCHs, may be reported from a radio base station to a user terminal.

For example, this information about linkages may be reported from radio base stations to user terminals on a per cell basis, by using broadcast signals, or may be reported on a per user terminal basis by using RRC signaling. Also, given these linkages reported thus, a configuration may be employed in which the linking between PDSCH bands and PUSCH bands is changed dynamically when control signals (DCI) are reported.

Note that a PDSCH band or a PUSCH band here may be comprised of a plurality of narrow bands. By this means, it is possible to easily define the linkages among a plurality of narrow bands.

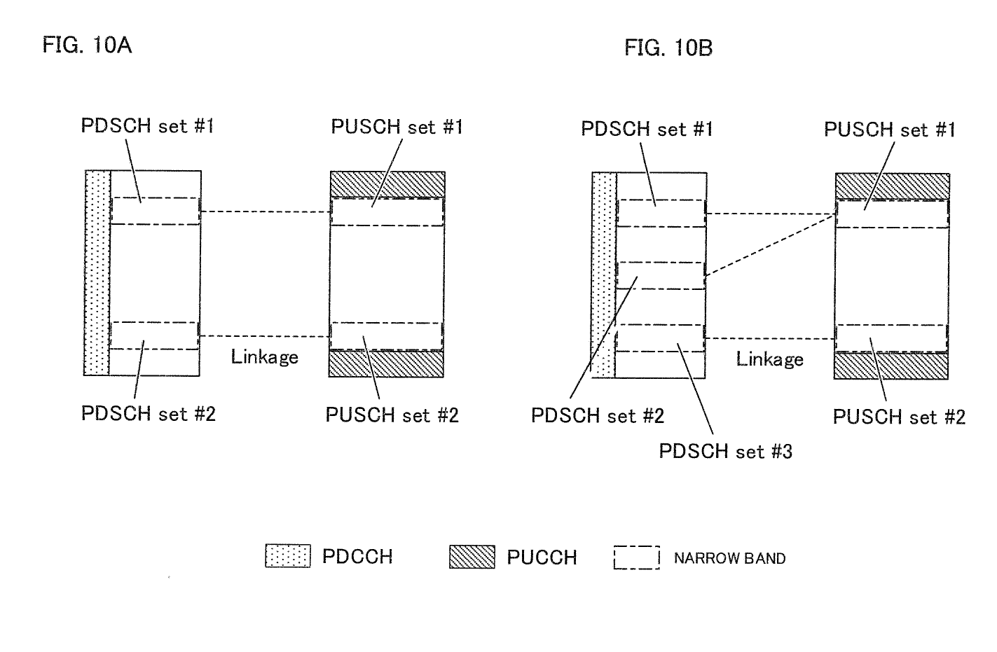

FIG. 10 is a diagram to show examples of linkages between PDSCH sets and PUSCH sets. In FIG. 10A, PDSCH set #1 and PUSCH set #1 are linked, and PDSCH set #2 and PUSCH set #2 are linked. In this way, PDSCH sets and PUSCH sets may be linked on a one-to-one basis.

In FIG. 10B, PDSCH set #1 and PDSCH set #2 are linked with PUSCH set #1, and PDSCH set #3 and PUSCH set #2 are linked. In this way, PDSCH sets and PUSCH sets may be linked on a many-to-one basis. Also, similarly, PDSCH sets and PUSCH sets may be linked on a one-to-many basis or on a many-to-many basis.

By this means, user terminals can easily identify narrow bans where PUCCHs (PUSCHs) can be used, based on narrow bands where EPDCCHs (PDSCHs) are allocated.

(Structure of Radio Communication System)

Now, the structure of the radio communication system according to an embodiment of the present invention will be described below In this radio communication system, the radio communication methods according to the embodiments of the present invention are employed. Note that the radio communication methods of the above-described embodiments may be applied individually or may be applied in combination. Here, although MTC terminals will be shown as examples of user terminals in which the band to use is limited to narrow bands, the present invention is by no means limited to MTC terminals.

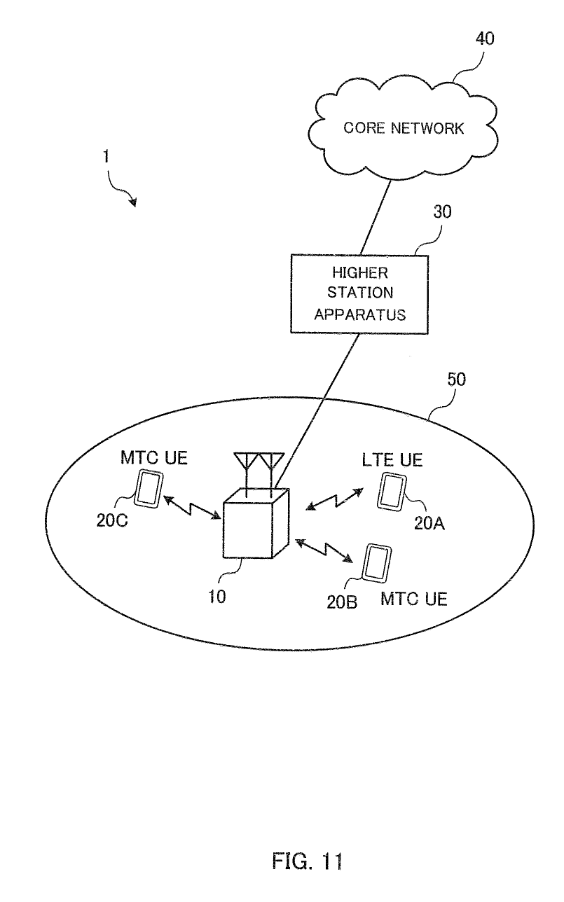

FIG. 11 is a diagram to show a schematic structure of the radio communication system according to an embodiment of the present invention, The radio communication system 1 shown in FIG. 11 is an example of employing an LTE system in the network domain of a machine communication system. The radio communication system 1 can adopt carrier aggregation (CA) and/or dual connectivity (DC) to group a plurality of fundamental frequency blocks (component carriers) into one, where the LTE system bandwidth constitutes one unit

Also, although, in this LTE system, the system band is configured to maximum 20 MHz in both the downlink and the uplink, this configuration is by no means limiting. Note that the radio communication system 1 may be referred to as “SUPER 3G,” “LTE-A” (LTE-Advanced), “IMT-Advanced,” “4G,” “5G,” “FRA” (Future Radio Access) and so on.

The radio communication system 1 is comprised of a radio base station 10 and a plurality of user terminals 20A, 20B and 20C that are connected with the radio base station 10. The radio base station 10 is connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these.

A plurality of user terminal 20A, 20B and 20C can communicate with the radio base station 10 in a cell 50. For example, the user terminal 20A is a user terminal that supports LTE (up to Rel-10) or LTE-Advanced (including Rel-10 and later versions) (hereinafter referred to as an “LTE terminal”), and the other user terminals 20B and 20C are MTC terminals that serve as communication devices in machine communication systems. Hereinafter the user terminals 20A, 20B and 20C will be simply referred to as “user terminals 20,” unless specified otherwise.

Note that the MTC terminals 20B and 20C are terminals that support various communication schemes including LTE and LTE-A, and are by no means limited to stationary communication terminals such electric (gas) meters, vending machines and so on, and can be mobile communication terminals such as vehicles. Furthermore, the user terminals 20 may communicate with other user terminals directly, or communicate with other user terminals via the radio base station 10.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system I, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, MIBs (Master Information Blocks) are communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH is frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data and higher layer control information are communicated by the PUSCH. Also, downlink radio quality information (CQI: Channel Quality Indicator), delivery acknowledgement signals and so on are communicated by the PUCCH. By means of the PRACH, random access preambles (RA preambles) for establishing connections with cells are communicated.

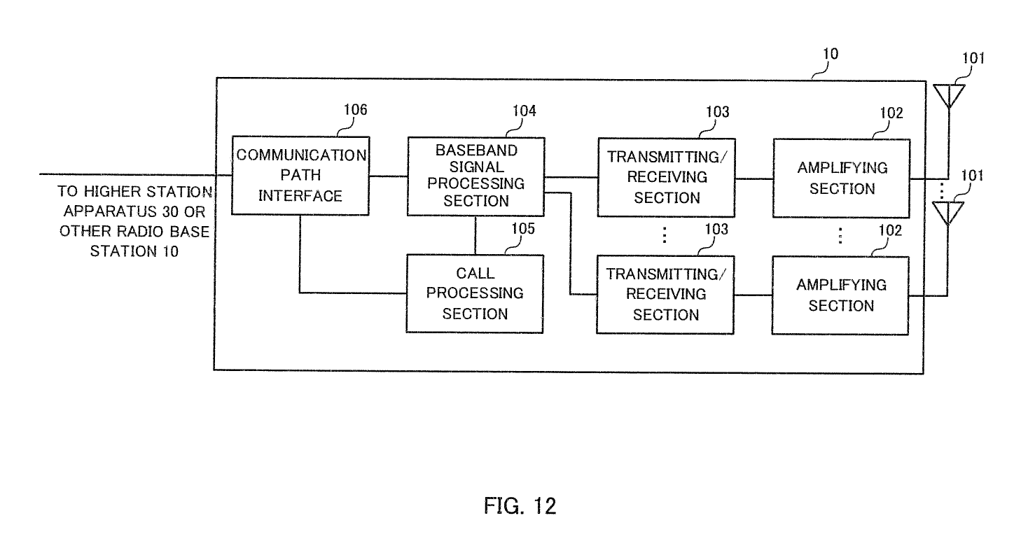

FIG. 12 is a diagram to show an example of an overall structure of a radio base station according to one embodiment of the present invention. A radio base station 10 has a plurality of transmitting/receiving antennas 101, amplifying sections 102, transmitting/receiving sections 103, a baseband signal processing section 104, a call processing section 105 and a communication path interface 106. Note that the transmitting/receiving sections 103 are comprised of transmitting sections and receiving sections.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts baseband signals that are pre-coded and output from the baseband signal processing section 104 on a per antenna basis, into a radio frequency band. The radio frequency signals subjected to frequency conversion in the transmitting/receiving sections 103 are amplified in the amplifying sections 102, and transmitted from the transmitting/receiving antennas 101. The transmitting/receiving sections 103 can transmit and receive various signals in narrow bands that are limited more than the system band.

For the transmitting/receiving sections 103, transmitters/receivers, transmitting/receiving circuits or transmitting/receiving devices that can be described based on common understanding of the technical field to which the present invention pertains can be used.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. The communication path interface 106 transmits and receives signals to and from neighboring radio base stations 10 (backhaul signaling) via an inter-base station interface (for example, optical fiber, the X2 interface, etc.).

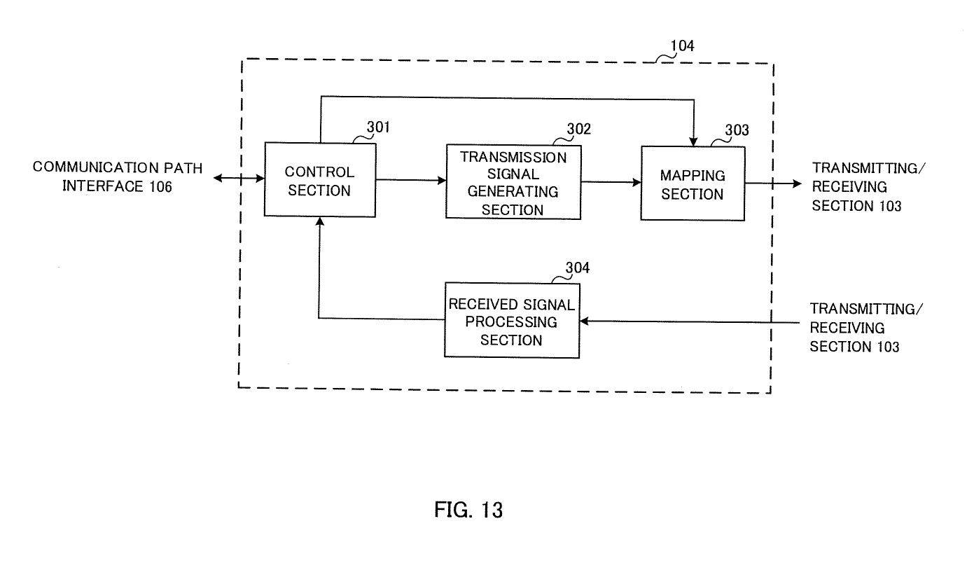

FIG. 13 is a diagram to show an example of a functional structure of a radio base station according to the present embodiment. Note that, although FIG. 10 primarily shows functional blocks that pertain to characteristic parts of the present embodiment, the radio base station 10 has other functional blocks that are necessary for radio communication as well. As shown in FIG. 13, the baseband signal processing section 104 has a control section (scheduler) 301, a transmission signal generating section (generating section) 302, a mapping section 303 and a received signal processing section 304.

The control section (scheduler) 301 controls the scheduling of (for example, allocates resources to) downlink data signals that are transmitted in the PDSCH and downlink control signals that are communicated in the PDCCH and/or the EPDCCH. Also, the control section 301 controls the scheduling of downlink reference signals such as system information, synchronization signals, the CRS (Cell-specific Reference Signal), the CSI-RS (Channel State Information Reference Signal) and so on. Also, the control section 301 controls the scheduling of uplink reference signals, uplink data signals that are transmitted in the PUSCH, uplink control signals that are transmitted in the PUCCH and/or the PUSCH, random access preambles that are transmitted in the PRACH, and so on.

The control section 301 controls the transmission signal generating section 302 and mapping section 303 to allocate various types of signals to narrow bands and transmit these to the user terminals 20. For example, the control section 301 controls downlink system information (MIBs, SIBs, etc.) and EPDCCHs to be allocated to narrow bands.

Also, the control section 301 transmits PDSCHs to the user terminals 20 in predetermined narrow bands. Note that, when the radio base station 10 employs coverage enhancement, for example, the control section 301 may configure the number of times to repeat a DL signal for a predetermined user terminal 20, and repeat transmitting the DL signal based on this number of repetitions. Furthermore, the control section 301 may control this number of repetitions to be reported to the user terminal 20 in an EPDCCH control signal (DCI) or by using higher layer signaling (for example, RRC signaling, broadcast information, etc.).

Furthermore, the number of repetitions is configured for each user terminal 20, the control section 301 may report information about the subframes to make PUCCH transmission to each user terminal 20. For example, for this information, the control section 301 may control information about offsets in the time direction to be included and transmitted in DCI (method 1 in the second embodiment). Also, for this information, the control section 301 may control the maximum number of repetitions in the cell formed by the radio base station 10 (method 2 in the second embodiment).

Furthermore, if the number of times to repeat a UL signal (for example, a PUCCH) is configured in the user terminal 20, the control section 301 may control information about the number of repetitions to be included in DCI and transmitted to the user terminal 20 (third embodiment).

For the control section 301, a controller, a control circuit or a control device that can be described based on common understanding of the technical field to which the present invention pertains can be used.

The transmission signal generating section 302 generates DL signals based on commands from the control section 301 and outputs these signals to the mapping section 303. For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on.

Also, when repetitive DL signal transmission (for example, repetitive PDSCH transmission) is configured, the transmission signal generating section 302 generates the same DL signal over a plurality of subframes and outputs these signals to the mapping section 303.

For the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to predetermined narrow band radio resources (for example, maximum 6 resource blocks) based on command from the control section 301, and outputs these to the transmitting/receiving sections 103.

For the mapping section 303, mapper, a mapping circuit or a mapping device that can be described based on common understanding of the technical field to which the present invention pertains can be used.

The received signal processing section 304 performs the receiving processes (for example, demapping, demodulation, decoding and so on) of the UL signals that are transmitted from the user terminal (for example, delivery acknowledgement signals (HARQ-ACKs), data signals that are transmitted in the PUSCH, random access preambles that are transmitted in the PRACH, and so on). The processing results are output to the control section 301.

Also, by using the received signals, the received signal processing section 304 may measure the received power (for example, the RSRP (Reference Signal Received Power)), the received quality (for example, the RSRQ (Reference Signal Received Quality)), channel states and so on, by using the received signals. The measurement results may be output to the control section 301.

The receiving process section 304 can be constituted by a signal processor, a signal processing circuit or a signal processing device, and a measurer, a measurement circuit or a measurement device that can be described based on common understanding of the technical field to which the present invention pertains.

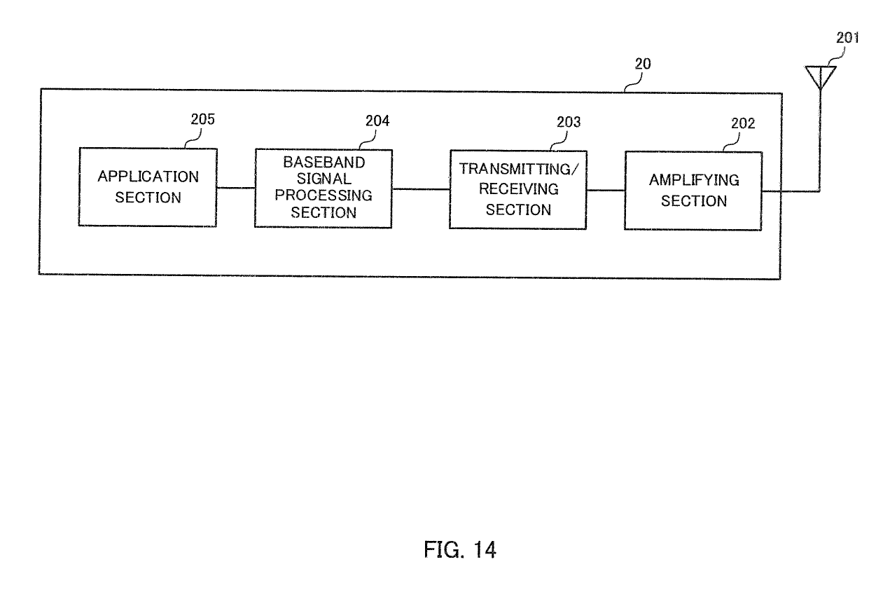

FIG. 14 is a diagram to show an example of an overall structure of a user terminal according to the present embodiment. Note that, although the details will not be described here, normal LTE terminals may operate and act as MTC terminals. A user terminal 20 has a plurality of transmitting/receiving antennas 201, amplifying sections 202, transmitting/receiving sections 203, a baseband signal processing section 204 and an application section 205. Note that, the transmitting/receiving sections 203 are comprised of transmitting sections and receiving sections. Also, the user terminal 20 has a plurality of transmitting/receiving antennas 201, amplifying sections 202, transmitting/receiving sections 203 and so on.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204.

For the transmitting/receiving sections 203, transmitters/receivers, transmitting/receiving circuits or transmitting/receiving devices that can be described based on common understanding of the technical field to which the present invention pertains can be used.

In the baseband signal processing section 204, the baseband signal that is input is subjected to an FFT process, error correction decoding, a retransmission control receiving process, and so on. Downlink user data is forwarded to the application section 205. The application section 205 performs processes related to higher layers above the physical layer and the MAC layer, and so on. Furthermore, in the downlink data, broadcast information is also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

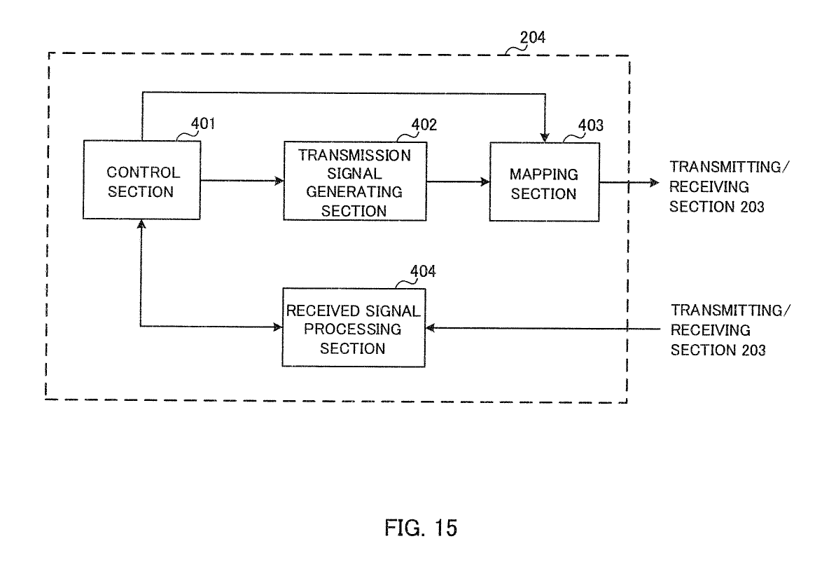

FIG. 15 is a diagram to show an example of a functional structure of a user terminal according to the present embodiment. Note that, although FIG. 15 primarily shows functional blocks that pertain to characteristic parts of the present embodiment, the user terminal 20 has other functional blocks that are necessary for radio communication as well. As shown in FIG. 15, the baseband signal processing section 204 provided in the user terminal 20 has a control section 401, a transmission signal generating section 402, a mapping section 403 and a received signal processing section 404.

The control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403.

Furthermore, the control section 401 determines the PUCCH resources in predetermined subframes, controls the timings (subframes) to transmit PUCCHs, and so on.

To be more specific, the control section 401 controls PUCCH resources by using PDSCH PRB indices (first embodiment). For example, the control section 401 determines the PUCCH resources to use to transmit ACKs/NACKs in response to PDSCHs received in the received signal processing section 404, based on predetermined rules that link between PDSCH PRB indices and PUCCH resources (for example, PUCCH PRB indices) on a one-to-one basis.

Furthermore, the control section 401 may control PUCCHs to be transmitted by using the same PUCCH resources with other user terminals 20 that are connected to the radio base station 10 (serving cell) where the subject user terminal 20 is currently connected. To be more specific, the control section 401 may control the PUCCH resources to be shifted in the direction of time, subframe units, based on the information about the subframes to make PUCCH transmission, received from the radio base station 10, and transmitted (second embodiment),

Furthermore, when the number of times to repeat a UL signal (for example, a PUCCH) is congfigured in a user terminal 20, the control section 401 may control the user terminal 20 to increase and decrease the number of times to repeat a PUCCH based on information about the number of repetitions that is received from the radio base station 10 (third embodiment). Note that, as mentioned earlier, the control section 401 configures PUCCH resources based on signals or information transmitted from the radio base station 10, and therefore may be referred to as a “PUCCH resource configuration section,” a “PUCCH resource specifying section” and so on.

For the control section 401, a controller, a control circuit or a control device that can be described based on common understanding of the technical field to which the present invention pertains can be used.

The transmission signal generating section 402 generates signals based on commands from the control section 401, and outputs those signals to the mapping section 403, For example, the transmission signal generating section 402 generates uplink control signals such as delivery acknowledgement signals (HARQ-ACKs), channel state information (CSI) and so on, based on commands from the control section 401, Also, the transmission signal generating section 402 generates uplink data signals based on commands from the control section 401. For example,when a UL grant is included in a downlink control signal that is reported from the radio base station 10, the control section 401 commands the transmission signal generating section 402 to generate an uplink data signal.

Furthermore, when repetitive UL signal transmission (for example, repetitive PUCCH transmission) is configured, the transmission signal generating section 402 generates the same UL signal over a plurality of subframes and outputs these signals to the mapping section 403. The number of repetitions may be increase and/or decreased based on commands from the control section 401.

For the transmission signal generating section 402, a signal generator, a signal generating circuit or a signal generating device that can be described based on common understanding of the technical field to which the present invention pertains can be used.

The mapping section 403 maps the uplink signals generated in the transmission signal generating section 402 to radio resources (maximum 6 resource blocks) based on commands from the control section 401, and output these to the transmitting/receiving sections 203.

For the mapping section 403, mapper, a mapping circuit or a mapping device that can be described based on common understanding of the technical field to which the present invention pertains can be used.

The received signal processing section 404 performs receiving processes (for example, demapping, demodulation, decoding and so on) of DL signals (for example, downlink control signals transmitted from the radio base station, downlink data signals transmitted in the PDSCH, and so on). The received signal processing section 404 outputs the information received from the radio base station 10, to the control section 401. The received signal processing section 404 outputs, for example, broadcast information, system information, RRC signaling, DCI and so on, to the control section 401.

Also, the received signal processing section 404 may measure the received power (RSRP), the received quality (RSRQ) and channel states, by using the received signals. Note that the measurement results may be output to the control section 401.

The received signal processing section 404 can be constituted by a signal processor, a signal processing circuit or a signal processing device, and a measurer, a measurement circuit or a measurement device that can be described based on common understanding of the technical field to which the present invention pertains. Also, the received signal processing section 404 can constitute the receiving section according to the present invention.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs.

Here, the processor and the memory are connected with a bus for communicating information, Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes. Here, these programs have only to be programs that make a computer execute each operation that has been described with the above embodiments. For example, the control section 4101 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of claims. Consequently, the description herein is provided only for the purpose of explaining example s, and should by no means be construed to limit the present invention in any way.

The disclosure of Japanese Patent Application No. 2014-226492, filed on Nov. 6, 2014, including the specification, drawings and abstract, is incorporated herein by reference in its entirety.

1. A user terminal, in which a band to use is limited to a partial narrow band in a system band, the user terminal comprising:
a receiving section that receives downlink control infoiiiiation that relates to a resource to allocate to a PDSCH (Physical Downlink Shared Channel), in an EPDCCH (Enhanced Physical Downlink Control Channel), and receives the PDSCH based on the downlink control information;
a transmission section that transmits a PUCCH (Physical Uplink Control Channel) in response to the PDSCH; and
a control section that controls a PUCCH resource based on a PRB (Physical Resource Block) index that corresponds to the PDSCH.

2. The user terminal according to claim 1, wherein the control section controls a transmission timing to transmit the PUCCH so that a same PUCCH resource is used as in another user terminal.

3. The user terminal according to claim 2, wherein the control section controls the transmission timing of the PUCCH based on predetermined information included in the downlink control information.

4. The user terminal according to claim 2, wherein the control section controls the transmission timing of the PUCCH based on a maximum number of times to repeat the PDSCH in a connecting radio base station.

5. The user terminal according to claim 1, wherein:
the transmission section repeats and transmits the PUCCH a predetermined number of times in a plurality of subframes; and
the control section controls the number of repetitions based on predetermined information included in the downlink control information.

6. The user terminal according to claim 3, wherein the predetermined information is an ARO (ACK/NACK Resource Offset) field.

7. The user terminal according to claim 1, wherein:
the downlink control information includes an ARI (ACK/NACK Resource Indicator) field; and
the control section controls a frequency resource to transmit the PUCCH based on the ARI field.

8. The user terminal according to claim 1, wherein:
the receiving section receives information about linkage between a candidate band that can be used to allocate the PDSCH and a candidate band that can be partially used to allocate the PUCCH; and
the control section determines a frequency resource to transmit the PUCCH based on the information about the linkage.

9. A radio base station that communicates with a user terminal in which a band to use is limited to a partial narrow band in a system band, the radio base station comprising:
a transmitting section that transmits downlink control information that relates to a resource to allocate to a PDSCH (Physical Downlink Shared Channel), in an EPDCCH (Enhanced Physical Downlink Control Channel), and transmits the PDSCH;
a receiving section that receives a PUCCH (Physical Uplink Control Channel) in response to the PDSCH; and
a control section that controls a resource to receive the PUCCH based on a PRB (Physical Resource Block) index that corresponds to the PDSCH.

10. A radio communication method for allowing a user terminal, in which a band to use is limited to a partial narrow band in a system band, to communicate with a radio base station, the radio communication method comprising the steps of:
receiving downlink control information that relates to a resource to allocate to a PDSCH (Physical Downlink Shared Channel), in an EPDCCH (Enhanced Physical Downlink Control Channel), and receiving the PDSCH based on the downlink control information;
transmitting a PUCCH (Physical Uplink Control Channel) in response to the PDSCH; and
controlling a PUCCH resource based on a PRB (Physical Resource Block) index that corresponds to the PDSCH.

11. The user terminal according to claim 5, wherein the predetermined information is an ARO (ACK/NACK Resource Offset) field.
